(19) United States
(12) Patent Application Publication
(10) Pub. No.: US 2011/0031097 A1
(43) Pub. Date: Feb. 10, 2011

(54) ELECTRICAL SWITCH ASSEMBLY WITH ANGLED PLUNGER

(76) Inventors: Arash Vakily, Mississauga (CA); Ronald K. Finlay, Toronto (CA); Christopher Larsen, Toronto (CA)

Correspondence Address: BLAKE, CASSELS & GRAYDON LLP, BOX 25, COMMERCE COURT WEST, 199 BAY STREET, SUITE 2800, TORONTO, ON, M5L 1A9, CA

(21) Appl. No.: 12/751,669

(22) Filed: Mar. 31, 2010

Related U.S. Application Data
(60) Provisional application No. 61/181,934, filed on May 28, 2009.

(51) Int. Cl. H01H 3/02

(52) U.S. Cl. 200/332

(57) ABSTRACT

An electrical switch assembly is provided comprising a housing; an actuator supported by the housing, the actuator having one or more downward extensions each having at least one rounded tip; an electrical circuit contained in the housing; an elastomeric pad comprising one or more collapsible domes overlying the electrical circuit; and one or more plunger elements supported in the housing between the at least one rounded tip and respective ones of the domes, the plunger element comprising a sloped surface to engage the rounded tip during movement of the actuator to cause the plunger element to collapse an underlying one of the domes.

This application claims priority from U.S. Provisional Application No. 61/181,934 filed on May 28, 2009, the contents of which are incorporated herein by reference.

### TECHNICAL FIELD

The following relates to electrical switches and in particular to plungers for actuating such switches.

### BACKGROUND

It is often desirable that switches activated by a user in automotive and other applications provide a tactile feedback to enable the user to discern between different switching stages and/or functions. In this way, the user can be made to experience force changes during operation of the switch that provide feedback to the user as to the state of the switch.

For example, when the switch is activated, the user may first feel an increasing resistance force, and then the force drops and the actuator stops in a first discernible position that indicates to the user that the switch is electrically activated. This first position is often referred to as the first detent. Some switches provide a secondary function such as in automobile window switches, which are configured to provide an “Auto-down” or “Express-down” or “One-touch down” option for the window. To activate this type of option, the user pushes the switch actuator in a downward direction beyond the first detent (or by pulling up for an “Auto-up” option) to a second discernible position or second detent. In this example therefore, the switch can be pushed or pulled to a first or second detent for each of two separate functions (in this case window down/window express-down or window up/window express-up). The pushing and pulling of a switch in this way may also be referred to as actuating the switch.

Two basic designs for providing such tactile feedback are prevalent, one being a spring-based tactile mechanism with separate electrical switching elements, and the other being a silicone rubber based membrane or elastomeric pad, often referred to as an “e-pad”, which provides a tactile response and electrical switching when interfaced with a printed circuit board (PCB). Both of these designs can suffer from limitations in force, travel, package size, and performance variations.

### SUMMARY

In one aspect, there is provided an electrical switch assembly comprising a housing; an actuator supported by the housing, the actuator having one or more downward extensions each having at least one rounded tip; an electrical circuit contained in the housing; an elastomeric pad comprising one or more collapsible domes overlying the electrical circuit; and one or more plunger elements supported in the housing between the actuator and respective ones of the domes, the plunger element comprising a sloped surface to engage the rounded tip during movement of the actuator to cause the plunger element to collapse an underlying dome.

In another aspect, there is provided a plunger element for actuating an underlying collapsible dome in an electrical switch assembly, the plunger element comprising a base portion for engaging the collapsible dome, and a body extending from the base portion, the body comprising an upwardly facing sloped surface to interact with an actuator having a portion moving in an arc towards the sloped surface and thereby effect downward movement of the plunger towards the dome.

### BRIEF DESCRIPTION OF THE DRAWINGS

Embodiments will now be described by way of example only with reference to the appended drawings wherein:

FIG. 1 is a pictorial view of a portion of the interior of an automobile comprising a set of electrical switch assemblies.

FIG. 2 is a perspective view of an electrical switch assembly in isolation.

FIG. 3 is an exploded perspective view of the electrical switch assembly shown in FIG. 2.

FIG. 4 is a perspective view of a set of plungers and elastomeric domes in isolation.

FIG. 5 is a cross-sectional view of the plungers and domes in FIG. 4 along plane A.

FIG. 6 is a cross-sectional view of the plungers and domes in FIG. 4 along plane B.

FIG. 7 is a profile view of a primary plunger shown in isolation.

FIG. 8 is a cross-section view illustrating activation of a plunger element via rotation of the actuator.

FIG. 9 is a force versus displacement graph for a sloped surface on the primary plunger of fifty-five degrees.

FIG. 10 is a force versus displacement graph for a sloped surface on the primary plunger of sixty degrees.

FIGS. 11(a) through 11(h) are free body diagrams illustrating force displacement and kinematic calculations for a plunger surface without curvature.

FIGS. 12(a) through 12(g) are free body diagrams illustrating force displacement and kinematic calculations for a plunger surface with curvature.

FIGS. 13(a) through 13(e) are cross-sectional views showing a series of activation stages for the actuator extensions and plunger elements.

FIGS. 14(a) through 14(c) are cross-sectional views showing a series of activation stages for the elastomeric domes.

FIG. 15 is graph showing travel versus force for the activation stages shown in FIGS. 14(a) to 14(c).

FIG. 16 is a graph showing angle versus force for an actuator during the activation stages.

FIG. 17 shows graphs illustrating angle versus force for two directions in one example of an electrical switch assembly comprising one up function and two down functions.

FIG. 18 is a force-displacement graph for a spring actuation embodiment.

### DETAILED DESCRIPTION OF THE DRAWINGS

The following provides a plunger element for actuating an electrical switch that enables the provision of a wider range of tactile profiles (force and travel) with coordinated electro-mechanical timing, using fewer components, with less sensitivity to variation of the components, and while enabling higher durability and reliability in a potentially smaller package size.

It has been found that providing plunger elements having a sloped surface to interact with a rounded or otherwise arcuate tip of an extension that moves with the actuator of the switch, enables single or dual actuation configurations in either or both directions with the above advantages can be achieved. This also enables changes to the tactile profile of the switch assembly to be made without changing the characteristics of an e-pad operated on by the plunger elements. It will be appreciated that the plunger elements and principles described herein may also be used with springs or other resilient members for actuating a PCB, however it should be noted that the tactile response generated by, e.g. springs, is typically different from e-pads as discussed below.

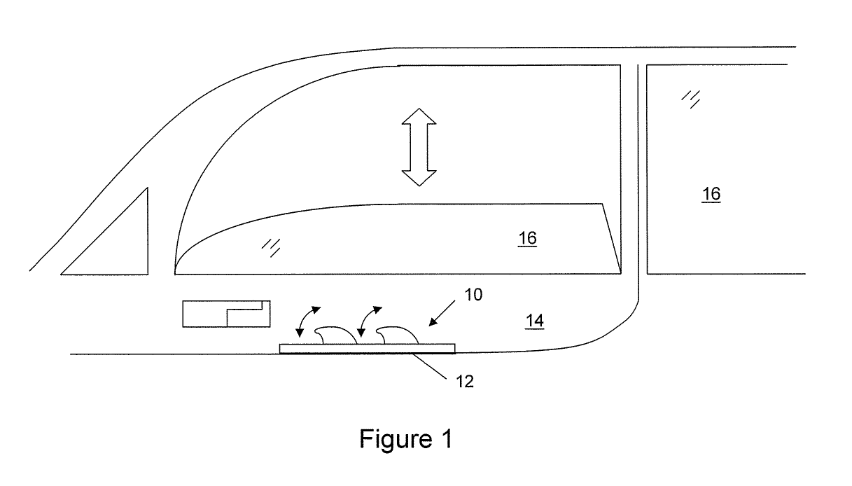

Turning now to FIG. 1, an example environment in which the plunger element and switch assembly may used is shown, wherein a set of electrical switch assemblies 10 is integrated into a console 12 of an automobile door 14 for operating a door window 16. In this example, two switch assemblies 10 can be seen in profile, one for a front window 16 and another for a rear window 16. It will be appreciated that more switch assemblies 10 may be included, e.g. to provide controls for another pair of front/rear windows 16 on an opposite side of the automobile (not shown). It will also be appreciated that the use of the switch assembly 10 and its components in an automotive application is only one example and various other uses are applicable as will be apparent in the following description.

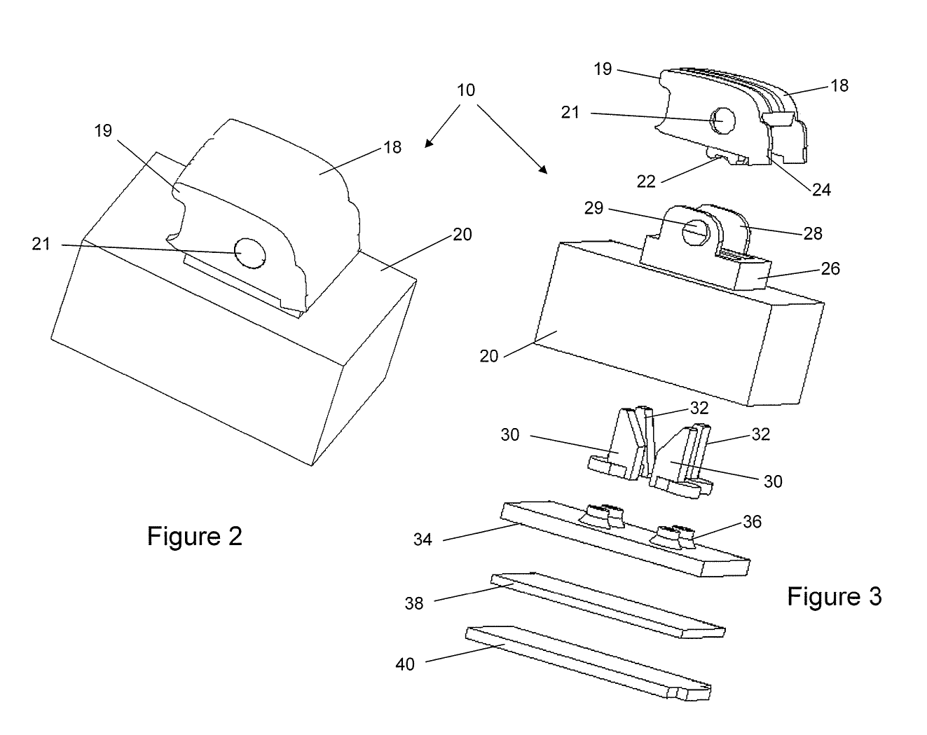

FIG. 2 shows an enlarged view of the switch assembly 10 in isolation. The switch assembly 10 is operated using an actuator 18, in this example a knob or rocker style member providing limited rotary movement and which can be actuated by rotation about its axis defined by attachment points 21. The actuator 18 comprises a lip 19 or other protrusion enabling the actuator 18 to be “pulled” in an upward direction thus rocking the actuator 18 back in the opposite direction. The actuator 18 also comprises a broad upper surface which can be “pressed” in a downward direction thus rocking the actuator forward. Also shown in FIG. 2 is a housing 20 which is used to contain, guide and support the various components of the switch assembly 10. The housing 20 may be a separate component as shown in FIG. 2 or may be integrated with other assemblies via the console 12 shown in FIG. 1. It will be appreciated that the housing 20 shown in FIG. 2 is for illustrative purposes only.

FIG. 3 shows an exploded perspective view of a switch assembly 10. From this view it can be seen that the actuator 18 is supported atop the housing 20 using a pair of upstanding supports 28 that provide protruding elements 29 that interact with corresponding apertures 21 in opposite sidewalls of the actuator 18. The supports 28 extend from an actuator base 26 which is in turn supported by or attached to the housing 20. The actuator 18 includes a primary extension 22 and a secondary extension 24 that each protrude downwardly towards the housing 20, and move conjointly with the actuator 18. The actuator base 26 comprises an aperture or opening which permits the extensions 22, 24 to extend into the interior of the housing 20.

As discussed above, the housing 20 contains various components of the switch assembly 10. In this example, the housing 20 comprises a open lower end (not shown) and a housing base 40 is provided, which supports and holds components within the housing and is used to close the housing 20. The housing base 40 provides support for a PCB 38, which supports an overlying e-pad 34 comprising a set of collapsible domes 36. The collapsible domes 36 are aligned with and are operated on by two pairs of plunger elements, a pair of primary plunger elements 30 and a pair of secondary plunger elements 32. The interior of the housing 20 is configured to restrict fore/aft and lateral movements of the plunger elements 30, 32 (see FIGS. 5 and 6) while permitting vertical movement, to enable the plunger elements 30, 32 to operate on and collapse the underlying domes 36 aligned therewith. The primary extension 22 is aligned with a least a portion of each of the primary plunger elements 30 to actuate a first switch operation, and the secondary extension 24 is aligned with at least a portion of each of the secondary plunger elements 32 to actuate a second switch operation. The geometry of the extensions 22, 24 and the plunger elements 30, 32 are selected such that the activation of the primary plunger elements 30 and secondary plunger elements 32 is sequential as will be explained in greater detail below.

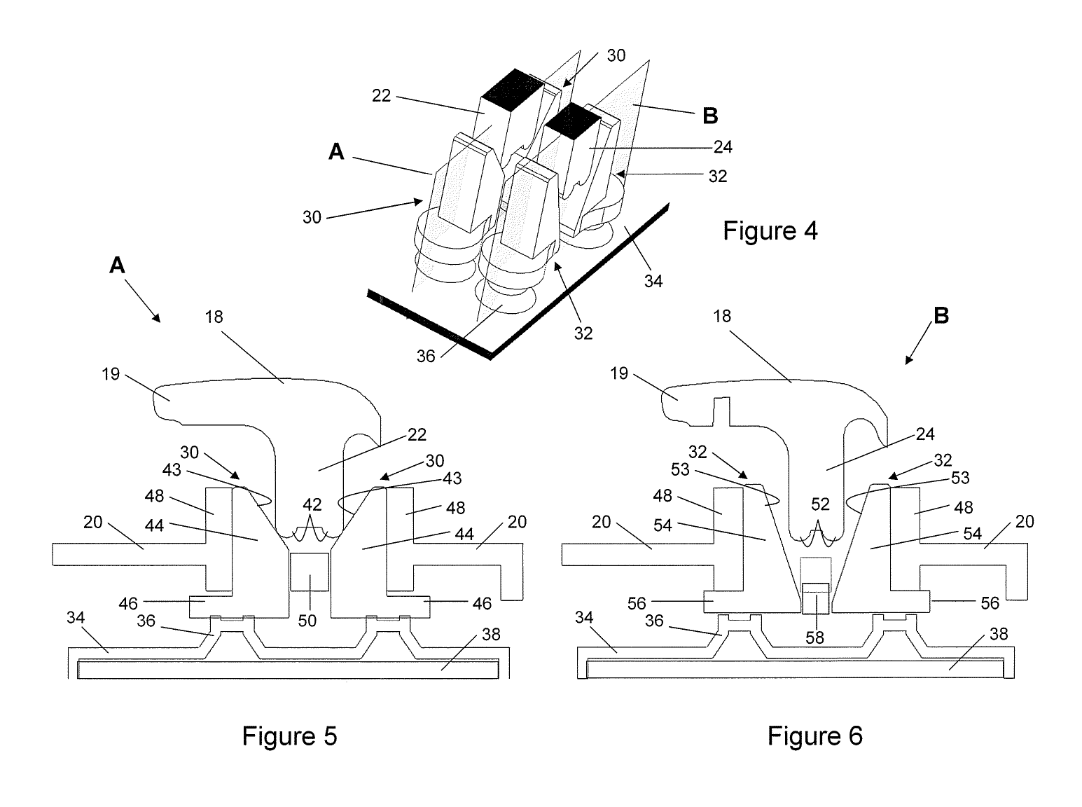

The relative arrangement of the extensions 22, 24 and the plunger elements 30, 32 is shown in greater detail in FIGS. 4 to 6. One of the primary plunger elements 30 and one of the secondary plunger elements 32 is arranged on either side of the axis of rotation of the actuator 18 such that a forward or “pressing” action operates one pair of primary/secondary plunger elements 30, 32 sequentially while a backward or “pulling” action operates on the other pair of primary/secondary plunger elements 30, 32.

As best seen in FIGS. 5 and 6, at rest, the primary plunger elements 30 are closer to the extensions 22 than the secondary plunger elements 30 are to the extensions 24. In this example, only the primary plunger elements 30 are in contact with the respective extension 22, however it can be appreciated that some tolerances are permitted. At a defined point of actuation (and depending on the direction of actuation) the other extension 24 comes into contact with one of the secondary plunger elements 32. Referring first to FIG. 5, the width of the extension 22 is sized such that a pair of arcuate, in this example substantially rounded primary extension tips 42 are in contact with respective primary sloped surfaces 43 of the primary plunger elements 30 when the switch assembly 10 is in a neutral or “rest” position. The sloped surfaces 43 are formed on respective upstanding primary plunger bodies 44, which extend from respective primary plunger bases 46. The plunger bases 46 are sized and oriented such that they are aligned with respective ones of the domes 36. The primary plunger elements 30 are guided within the housing 20 using a pair of integrated outer guide members 48 that are formed on either side of a primary central guide member 50 to thus maintain positioning of the primary plunger elements 30 and limit lateral and fore/aft movements to decrease rattling that can be caused by vibration.

Referring now to FIG. 6, it can be observed that the width of the secondary extension 24 is less than that of the primary extension 22 and thus a pair of arcuate, in this example substantially rounded secondary extension tips 52 are separated from respective secondary sloped surfaces 53 of the secondary plunger elements 32 when the switch assembly 10 is in the neutral position as shown. In this way, movement of the actuator 18 will cause the extension 22 to operate on one of the primary plunger elements 30 prior to causing the extension 24 to operate on one of the secondary plunger elements 32. Similar to what is shown in FIG. 5, the secondary sloped surfaces 53 are formed on respective upstanding secondary plunger bodies 54, the plunger bodies 54 extending from respective secondary plunger bases 56. The secondary plunger elements 32 are also guided within the housing 20 using the pair of integrated outer guide members 48, and a secondary central guide member 58 which is positioned between the secondary plunger elements 32 to thus maintain positioning of the secondary plunger elements 32 to limit lateral and fore/aft movements to decrease rattling that can be caused by vibration. Guide elements 50 and 58 are, in this example, both integral to the housing 20 and in general are oriented and sized to hold the plunger elements 30, 32. In this example, guide elements 50, 58 comprise different cross sections of the same housing 20 and are part of the same component for synchronizing activation of primary and secondary sets of plunger elements 30, 32.

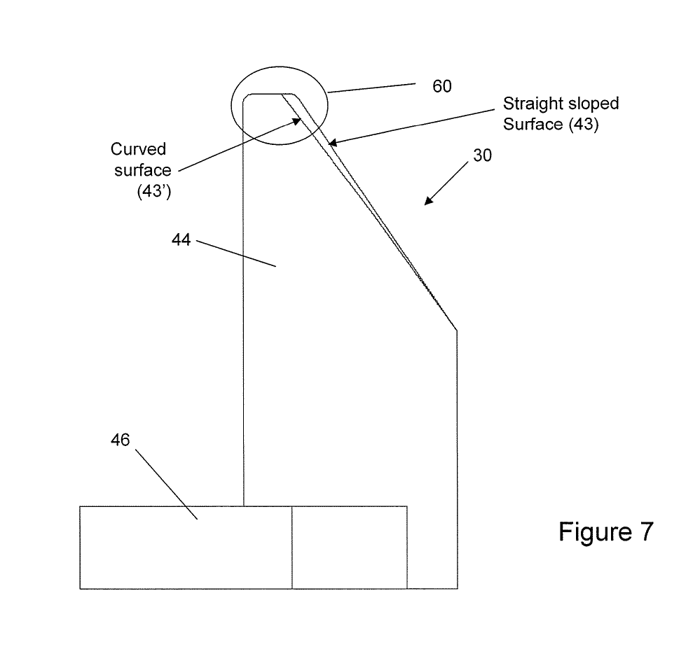

FIG. 7 shows one of the primary plunger elements 30 in isolation. It can be seen that the tip portion 60 of the plunger body 44 can be modified by changing the sloped surface 43 from a straight profile to a curved profile 43′ to provide more control over the tactile feel when operating on the primary plunger element 30. The exact tactile response can be mapped via calculations to the geometry of the primary plunger element 30 and the primary extension 22. It may be noted that the sloped surfaces 53 on the secondary plunger elements 32 can also be curved in the same way with the same result.

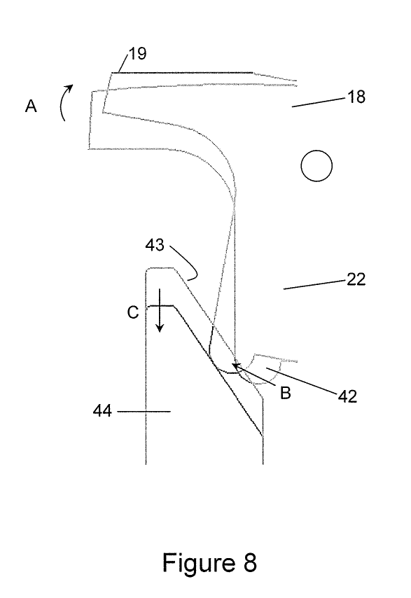

FIG. 8 shows the way in which the actuator extensions 22, 24 interact with the sloped surfaces 43, 53 of the plunger elements 30, 32, in this example showing an interaction between a primary extension 22 and a primary plunger element 30. Motion A is caused by rotating or “pulling” up the lip 19 of the actuator 18. As a result of motion A, the primary tip 42 moves along an arcuate path as illustrated by motion B. Motion B causes interference between the angled tip of the plunger body 44 and the sloped surface 43, thus causing the primary plunger element 30 to move in a downward direction as illustrated by motion C. When the actuator 18 is operated on, conjoint movement of the primary extension 22 causes the primary plunger element 30 to move downwardly in a substantially straight line due to the arrangement of the primary plunger element 30 between one of the outer guide members 48 and the primary inner guide member 50. It can be appreciated from FIG. 8 that the angle of the sloped surface 43, the radius of the rounded tip 42, and the distance between the rotation point of the actuator 18 and the primary plunger element 30 control the amount of force and travel that the user feels when rotating the actuator 18. It will be appreciated that similar principles apply to the operation of the secondary plunger elements 32.

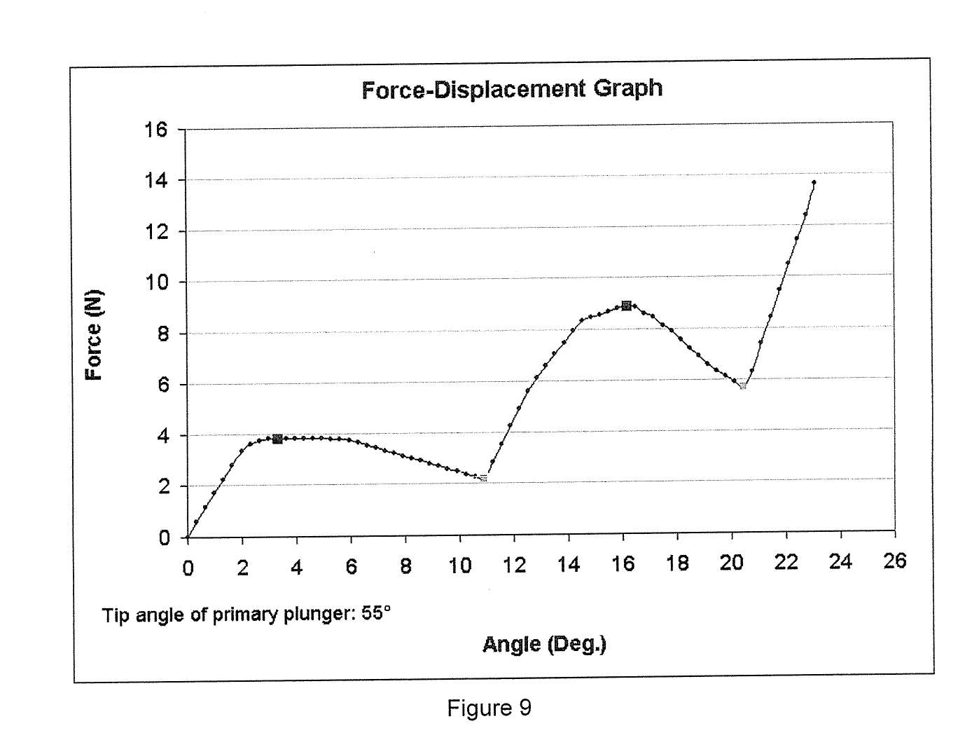

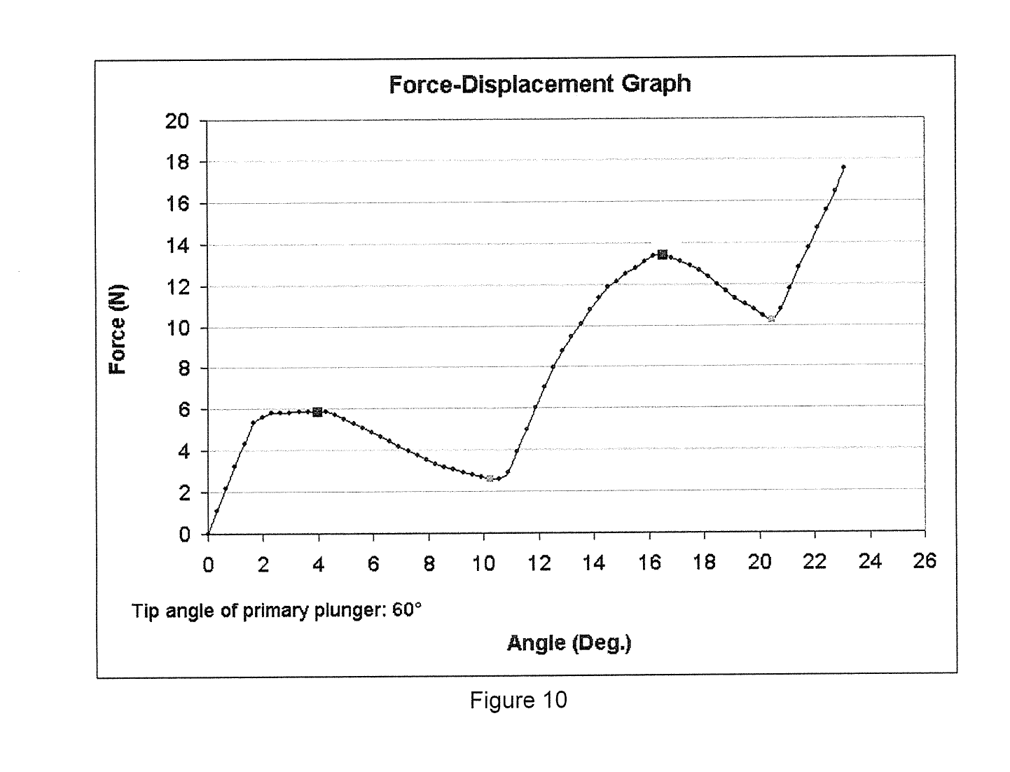

FIGS. 9 and 10 illustrate the change in the force-displacement curve when changing the angle of the sloped surface 43 from 55° to 60° and the corresponding increase in force required to achieve the snap-over point prior to each switching stage.

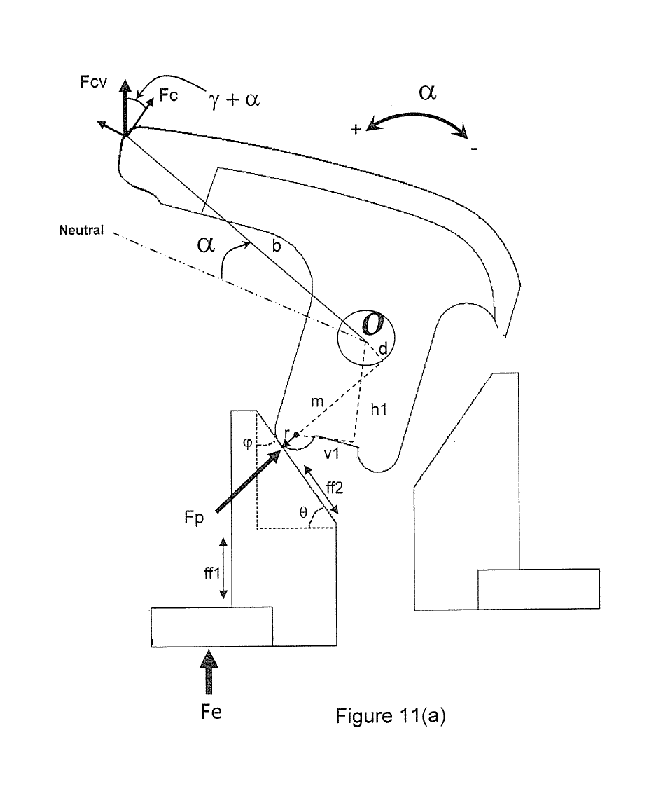

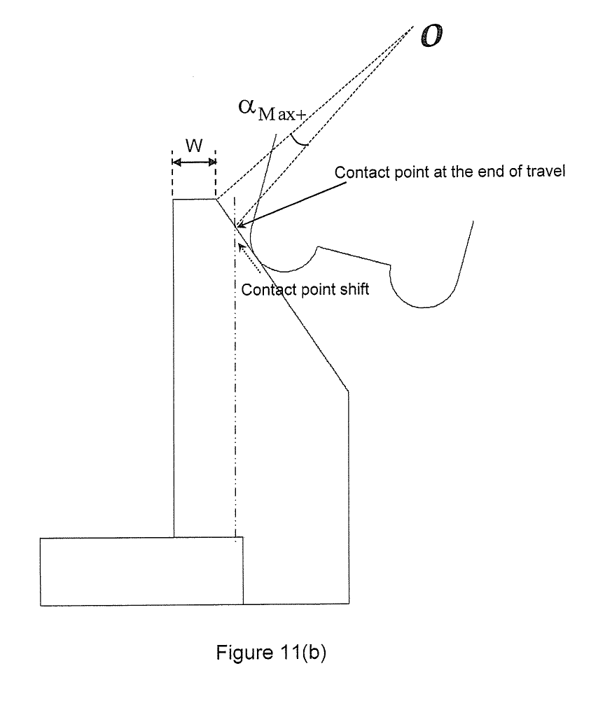

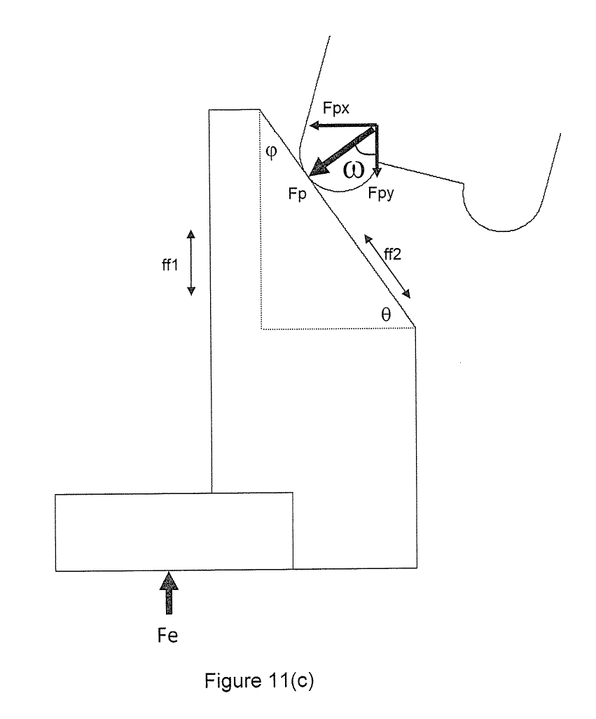

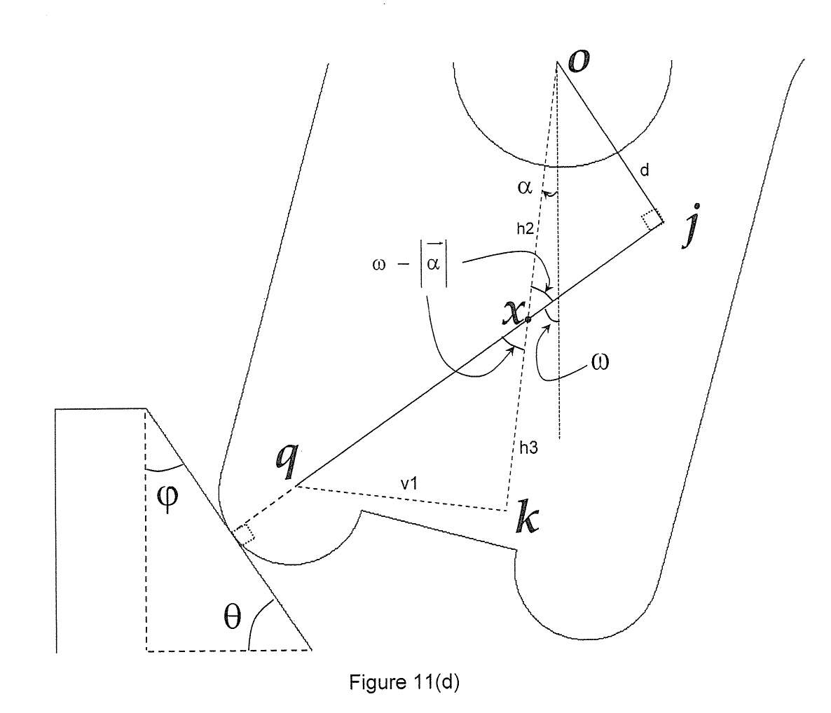

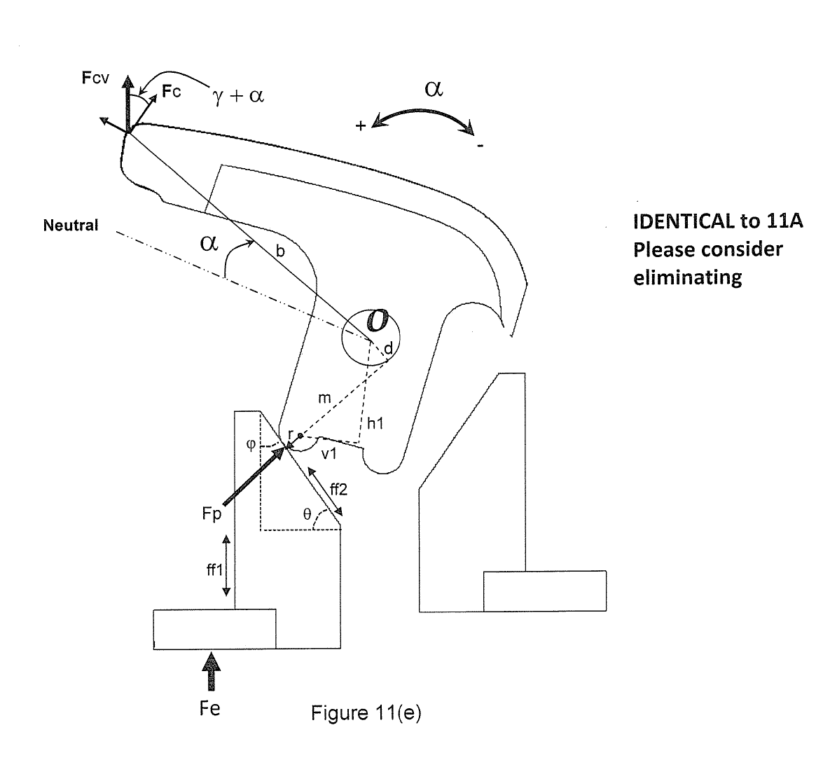

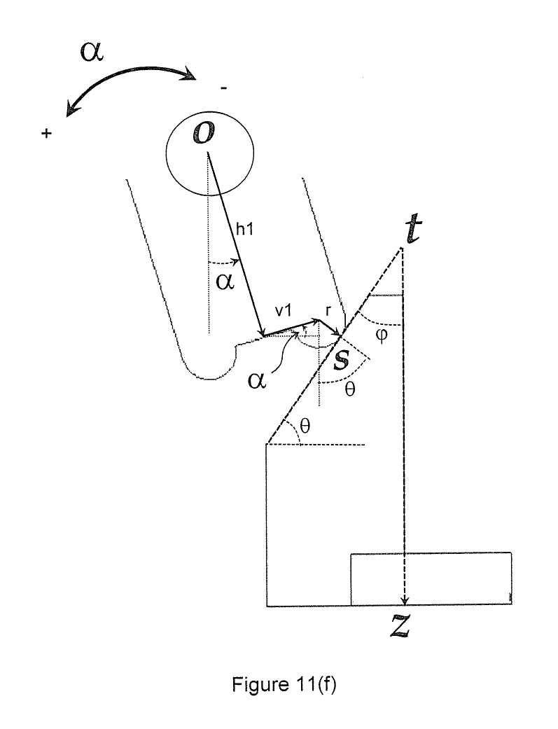

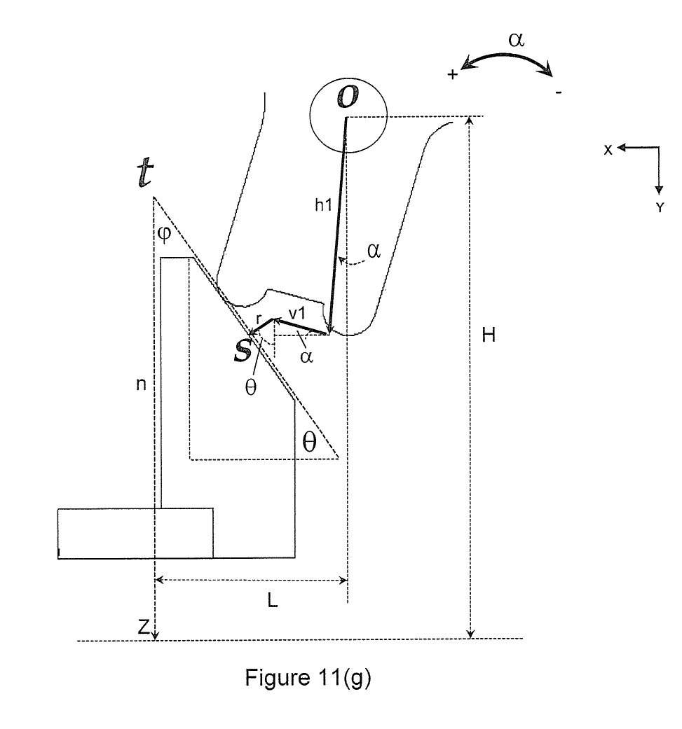

As noted above, variations in the geometry of the actuator extensions 22, 24 and the plunger elements 30, 32 can be made to affect the tactile response of the switch assembly 10. Referring now to FIGS. 11(a) through 11(h) various calculations pertaining to the geometry will now be provided, for a plunger element 30 without a curved tip portion 60, to illustrate how such variations can be determined.

The following is a list of variables shown in FIGS. 11(a) to 11(h) and their definitions:

Fc—Force on actuator 18, in tangent direction to rotation arc/perpendicular to radius of rotation

Fcv—Force on actuator 18 in vertical (Z) direction

Fe—Force from e-pad 34 (elastomeric key-top)

α—Angle of rotation of the actuator 18

γ—Angle of point of activation of actuator 18 to centre of rotation to horizontal line at neutral

b—Distance between point of activation of actuator 18 to centre of rotation (moment arm of the actuator 18)

h, h1, h2—Height of actuator extension 22 to centre of rotation

v, v1, v2—Width of actuator extension 22 to centre of rotation

r, r1, r2—Radius of rounded tips 42

θ—Angle of sloped surface 43 of the plunger element 30 to horizontal line

φ—Angle of sloped surface 43 of the plunger element 30 to vertical line

ff1—Friction force between plunger element 30 and outer guide element 48

ff2—Friction force between plunger element 30 and actuator extension 22

μ1—Coefficient of friction between plunger element 30 and outer guide element 48

μ2—Coefficient of friction between plunger element 30 and actuator extension 22

Fp—Perpendicular force exerted from rounded tip 42 to sloped surface 43

Fpx—Horizontal component of Fp

Fpy—Vertical component of Fp

d—Moment arm of Fp on the actuator 18 when rotating

m—Moment arm of ff2 on the actuator 18 when rotating

L—Horizontal distance between centre of rotation and outboard vertical face of plunger element 30

n—Vertical distance between bottom face of plunger element 30 and arbitrary intersection point of outer surface and sloped surface 43

H—Vertical distance between bottom face of plunger element 30 and centre of rotation of actuator 18

H0—H at neutral position (α=0)

ΔH—Change of vertical position of plunger element 30=e-pad compression at any angle

Hᵤₚ—H for opposing plunger element 30 at first few degrees of rotation when preload is in effect=amount that opposing e-pad 34 rises

W+—Extra plunger element width for over-snap protection

α+max—Extra angular actuator travel for over-snap protection

FIGS. 11(a) and 11(b) incorporate the above variables. Turning now to FIG. 11(c), sample force calculations are provided below. To begin, ΣFy=0; ff1=μ1.Fpx; and ff2=μ2.Fp. As such, for activation:

$$Fe + ff 1 + ff 2 \cdot Sin θ = Fpy ⇒ Fe + μ1 \cdot Fpx + μ 2 \cdot \overbrace{Fp \cdot Sin θ}^{Fpx} = Fpy \qquad ( 1 )$$

and for deactivation:

$$Fe - ff 1 - ff 2 \cdot Sin θ = Fpy ⇒ Fe - μ 1 \cdot Fpx - μ 2 \cdot \underbrace{Fp \cdot Sin θ}_{Fpx} = Fpy . \qquad ( 2 )$$

Also:

$$\begin{matrix}tan θ = \frac{Fpx}{Fpy} ⇒ Fpx = Fpy tan θ ; and & ( 3 ) \\ Cos θ = \frac{Fpy}{Fp} ⇒ Fpy = Fp Cos θ , & ( 4 )\end{matrix}$$

therefore, for activation:

Fe+μ1.Fpy.tan θ+μ2.Fpy tan θ=Fpy [symbol] Fe=Fpy(1−μ1.tan θ−μ2.tan θ) (5);

and for deactivation:

Fe−μ1.Fpy.tan θ−μ2.Fpy.tan θ=Fpy [symbol] Fe=Fpy(1+μ1.tan θ+μ2.tan θ) (6).

From equation (4), Fpy=Fp Cos θ, therefore: for activation:

Fe=Fp.Cos θ(1−μ1.tan θ−μ2.tan θ) (7);

and for deactivation:

Fe=Fp.Cos θ(1+μ1.tan θ+μ2.tan θ) (8).

Reference may now be made to FIG. 11(d). It is noted that |\vec{α}| is shown in the negative direction but if shown in the positive direction, the same results are obtained. In FIG. 11(d), KO=h1, XO=h2, KX=h3; and h1=h2+h3 (9). Also,

$$Δ XQK : tan ( θ - \vert {α}^{->} \vert ) = \frac{v 1}{h 3} ⇒ h 3 = \frac{v 1}{tan ( θ - \vert {α}^{->} \vert )} , \\ Δ X JO : sin ( θ - \vert {α}^{->} \vert ) = \frac{d}{h 2} ⇒ h 2 = \frac{d}{sin ( θ - \vert {α}^{->} \vert )} , and \\ ⇒ h 2 + h 3 = \frac{v 1}{tan ( θ - \vert {α}^{->} \vert )} + \frac{d}{sin ( θ - \vert {α}^{->} \vert )} = \frac{v 1 Cos ( θ - \vert {α}^{->} \vert ) + d}{sin ( θ - \vert {α}^{->} \vert )} .$$

### Accordingly,

$$h 1 = \frac{v 1 Cos ( θ - \vert {α}^{->} \vert ) + d}{sin ( θ - \vert {α}^{->} \vert )} . \qquad ( 10 )$$

Now,

$$d = h 1 Sin ( θ - \vert {α}^{->} \vert ) - \frac{v 1 Sin ( θ - \vert {α}^{->} \vert )}{tan ( θ - \vert {α}^{->} \vert )} ; \\ and \text{:} d = h 1 Sin ( θ - \vert {α}^{->} \vert ) - v 1 Cos ( θ - \vert {α}^{->} \vert ) . \qquad ( 11 )$$

Referring still to FIG. 11(d),

m=QJ (12);

and

QJ=QX+XJ (13)

and therefore:

$$\begin{matrix}Δ XQK \text{:} Sin ( θ - \vert {α}^{->} \vert ) = \frac{v 1}{QX} ⇒ QX = \frac{v 1}{Sin ( θ - \vert {α}^{->} \vert )} ; & ( 14 a ) \\ Δ XJO \text{:} tan ( θ - \vert {α}^{->} \vert ) = \frac{d}{XJ} ⇒ XJ = \frac{d}{tan ( θ - \vert {α}^{->} \vert )} ; and \\ \begin{matrix}QX + XJ = \frac{v 1}{Sin ( θ - \vert {α}^{->} \vert )} + \frac{d}{tan ( θ - \vert {α}^{->} \vert )} \\ = \frac{v 1 + d Cos ( θ - \vert {α}^{->} \vert )}{sin ( θ - \vert {α}^{->} \vert )} .\end{matrix} & ( 14 b )\end{matrix}$$

Accordingly,

$$m = \frac{v 1 + d Cos ( θ - \vert {α}^{->} \vert )}{sin ( θ - \vert {α}^{->} \vert )} , \qquad ( 15 )$$

where as noted above m is the moment arm for friction force between the actuator 18 and the plunger element 30.

Turning now to FIG. 11(e), ΣMo=0, namely the sum of moments around point “O” is zero; and ff2=μ2.Fp. As such, for activation:

$$\begin{matrix}- b \cdot Fc + d \cdot Fp + ff 2 ( m + r ) = 0 ⇒ b \cdot Fc \\ = Fp [ d + μ 2 ( m + r ) ] and \\ thus \text{:} Fc \\ = Fp ( \frac{d + μ 2 ( m + r )}{b} ) .\end{matrix} \qquad ( 16 )$$

For deactivation: −b.Fc+d.Fp−ff2(m+r)=0 [symbol] b.Fc=Fp[d−μ2(m+r)] and thus:

$$Fc = Fp ( \frac{d - μ 2 ( m + r )}{b} ) . \qquad ( 17 )$$

Using equations (7) and (16), for activation:

$$\frac{Fc}{Fe} = \frac{Fp ( \frac{d + μ 2 ( m + r )}{b} )}{Fp \cdot Cos θ ( 1 - μ 1 \cdot tan θ - μ 2 \cdot tan θ )} ;$$

and thus:

$$Fc = Fe ( \frac{d + μ 2 ( m + r )}{b \cdot Cos θ ( 1 - μ 1 \cdot tan θ - μ 2 \cdot tan θ )} ) . \qquad ( 18 )$$

Using equations (8) and (17), for deactivation:

$$\frac{Fc}{Fe} = \frac{Fp ( \frac{d - μ 2 ( m + r )}{b} )}{Fp \cdot Cos θ ( 1 + μ 1 \cdot tan θ + μ 2 \cdot tan θ )} ;$$

and thus:

$$Fc = Fe ( \frac{d - μ 2 ( m + r )}{b \cdot Cos θ ( 1 + μ 1 \cdot tan θ + μ 2 \cdot tan θ )} ) . \qquad ( 19 )$$

For equations (18) and (19), m can be calculated from equation (15) and d can be calculated from equation (11).

Turning next to FIGS. 11(f) and 11(g), sample kinematic calculations are provided below. As can be appreciated from these figures, the vector

$$\begin{matrix}\vert \vec{OSx} \vert = \vert h 1 \cdot Sin {α}^{->} \vert + \vert v 1 \cdot Cos {α}^{->} \vert + \vert r \cdot Sin θ \vert and & ( 20 ) \\ \vec{STx} = L - \vert \vec{OSx} \vert ⇒ \vec{ST} = \frac{L - \vert \vec{OSx} \vert}{Cos θ} . & ( 21 )\end{matrix}$$

### Also,

$$H = \vert \vec{OZy} \vert = \vert h 1 \cdot Cos {α}^{->} \vert - \vert v 1 \cdot Sin {α}^{->} \vert + \vert r \cdot Cos θ \vert - \vec{ST} \cdot Sin θ + {\underbrace{\vec{TZ}}}_{n}$$

and thus:

H=|h1.Cos \vec{α}|−|v1.Sin \vec{α}|+|r.Cos θ|−\vec{ST}.Sin θ+n (22).

Now, at α=0→H=H0 [symbol] n=H0−|h1.Cos \vec{α}|+|v1.Sin \vec{α}|−|r.Cos θ|+\vec{ST}.Sin θ and then:

n=H0−|h1|−|r.Cos θ|+\vec{ST}.Sin θ (23).

The change of vertical position of the plunger element 30 is therefore:

ΔAH=H−H0 (24).

Using equations (22) and (23): H=|h1.Cos \vec{α}|−|v1.Sin \vec{α}|+|r.Cos θ|−\vec{ST}.Sin θ+H0−|h1|−|r.Cos θ|+\vec{ST}.Sin θ and then:

H=|h1.Cos \vec{α}|−|v1.Sin \vec{α}|+H0−|h1| (25).

Next, using equations (24) and (25), the change in vertical position can be defined as follows:

ΔH=|h1.Cos \vec{α}|−|v1.Sin \vec{α}|−|h1 (26).

Making reference to FIG. 11(h) sample calculations are now provided that apply only to the first few degrees of rotation while preload is in effect. Forces derived from the opposing plunger element 30 are deducted from the main plunger element 30. As shown in FIG. 11(h),

|\vec{OSx}|ᵤₚ=−|h1.Sin \vec{α}|+|v1.Cos \vec{α}|+|r.Sin θ| (27).

From this it can be appreciated that

$$\begin{matrix}{H}_{up} = {\vert \vec{OZy} \vert}_{up} \\ = \vert h 1 \cdot Cos {α}^{->} \vert - \vert v 1 \cdot Sin {α}^{->} \vert + \vert r \cdot Cos θ \vert - \vec{ST} \cdot Sin θ + {\underbrace{\vec{TZ}}}_{n}\end{matrix}$$

and thus

Hᵤₚ=|h1.Cos \vec{α}|+|v1.Sin \vec{α}|+|r.Cos θ|−\vec{ST}.Sin θ+n (28).

To utilize the above calculations in determining suitable geometry, ΔH is calculated from equation (26) and from equation (28) for the preload zone. From the force/displacement of the e-pad dome 36, the e-pad force Fe is derived. The force on the actuator 18 is then calculated from equations (18) and (19) for activation and deactivation, respectively (and for the preload zone, force created by the opposing e-pad dome 36 is calculated and deducted from the main force). To calculate L (assigning extra plunger width and extra actuator rotation angle for overtravel/snap-over protection): a) calculate |OSx|ₘₐₓ by inserting full travel angle and α+ₘₐₓ in equation (20); and b) add W+ to this value to find L.

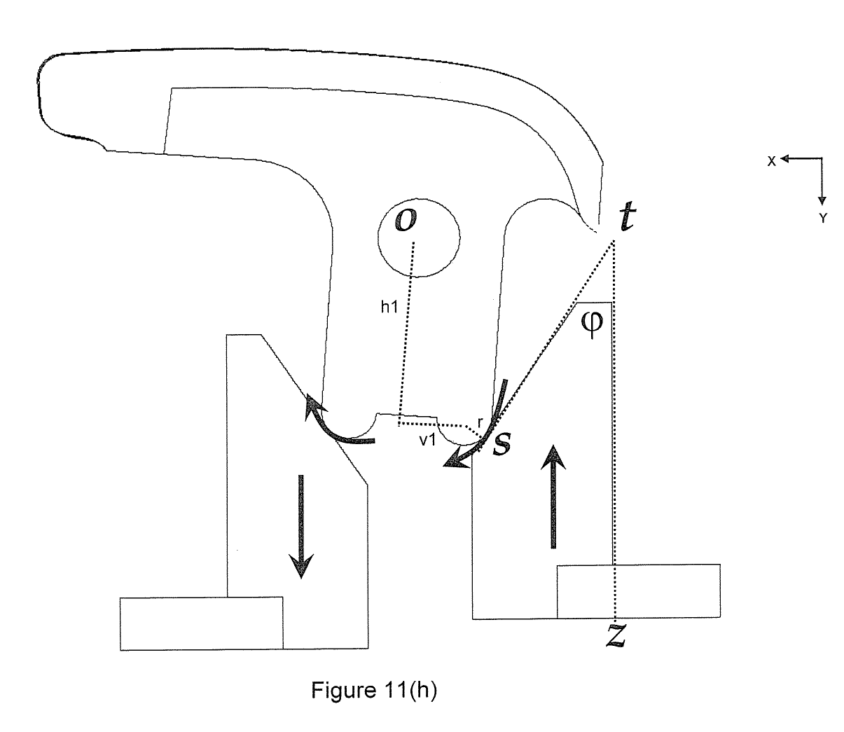

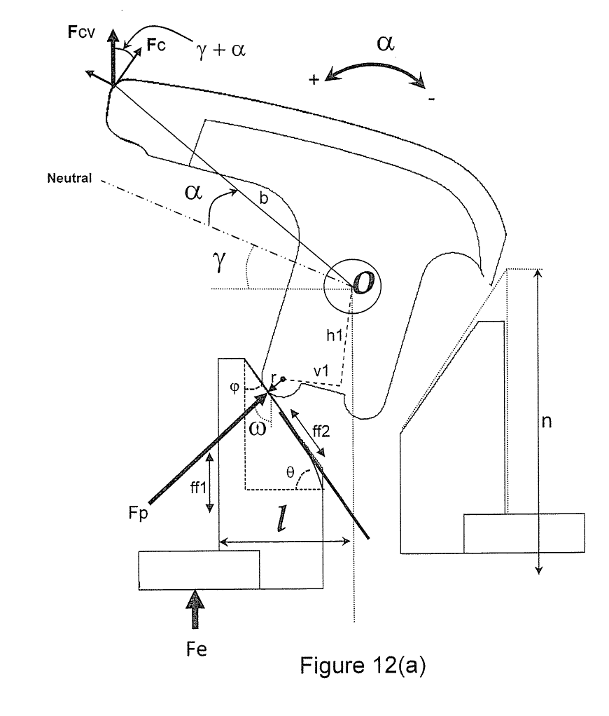

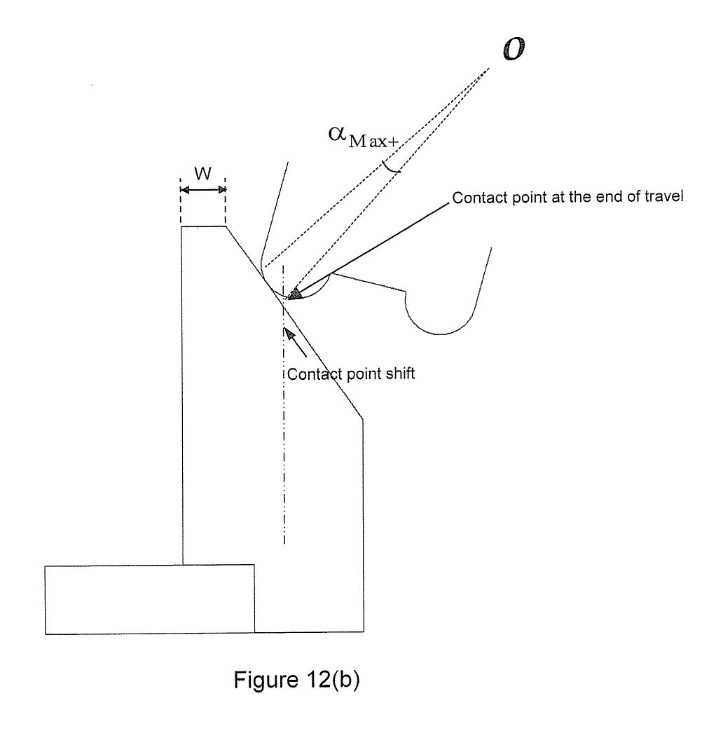

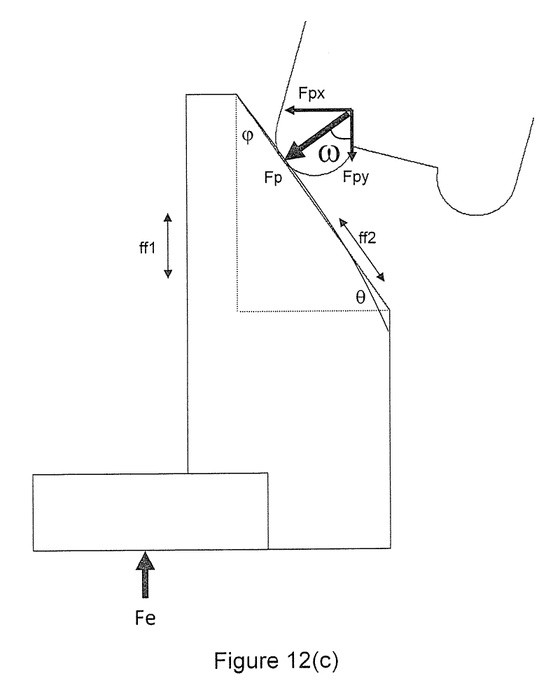

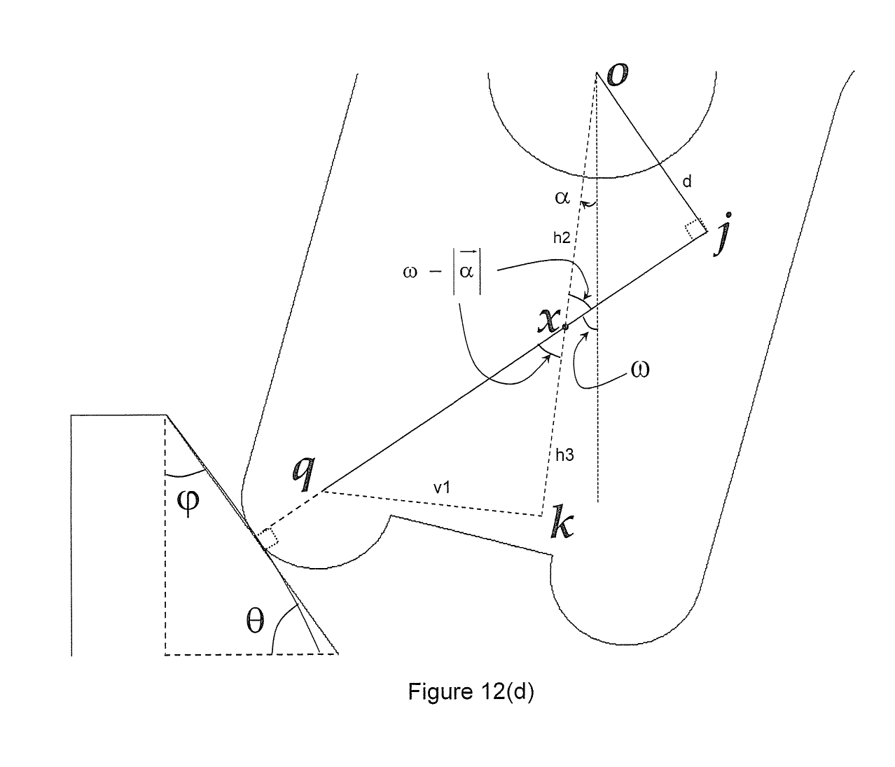

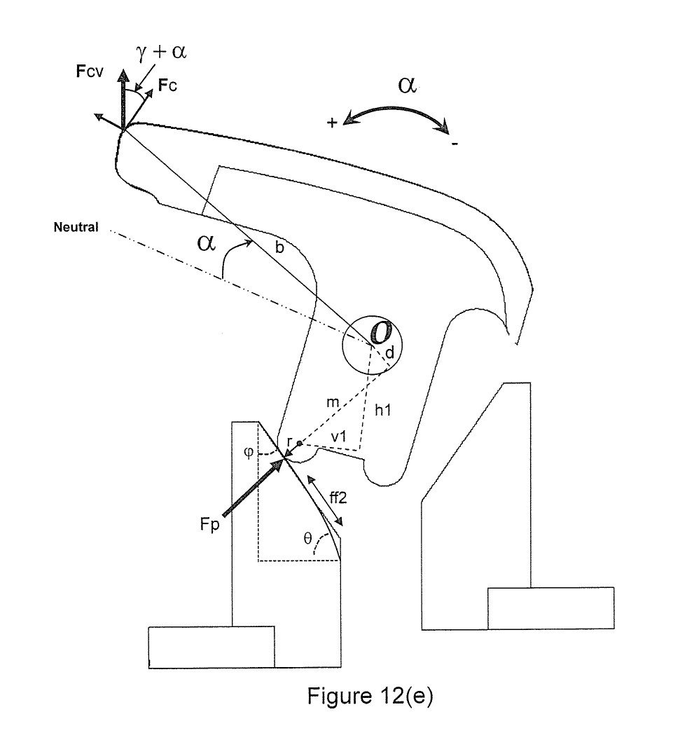

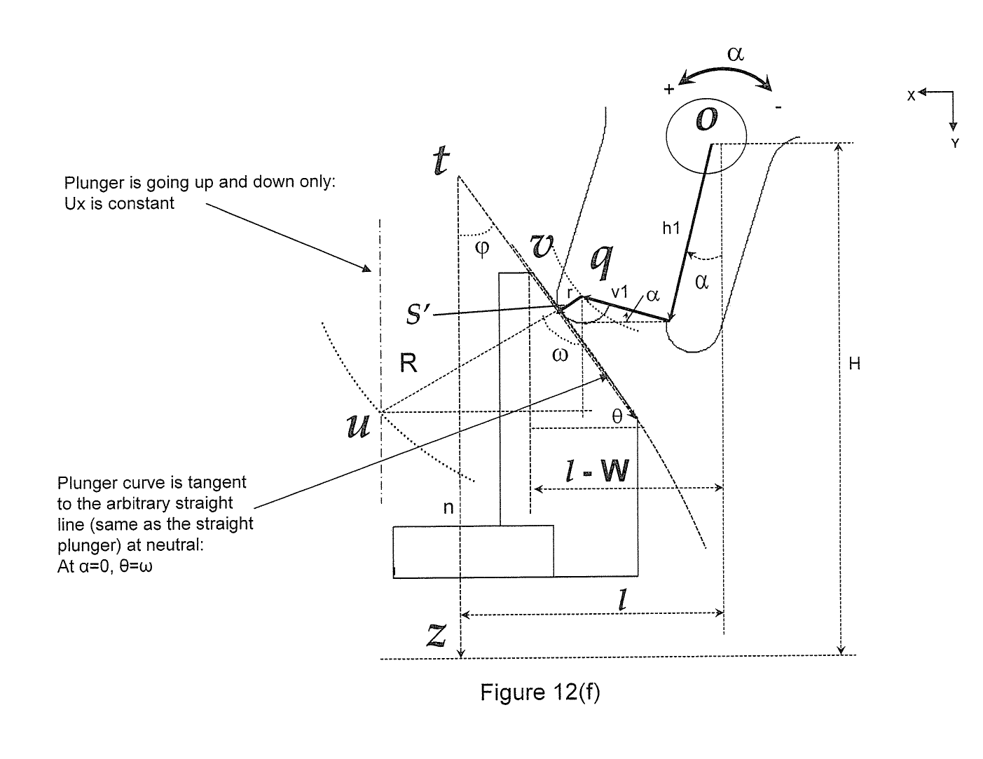

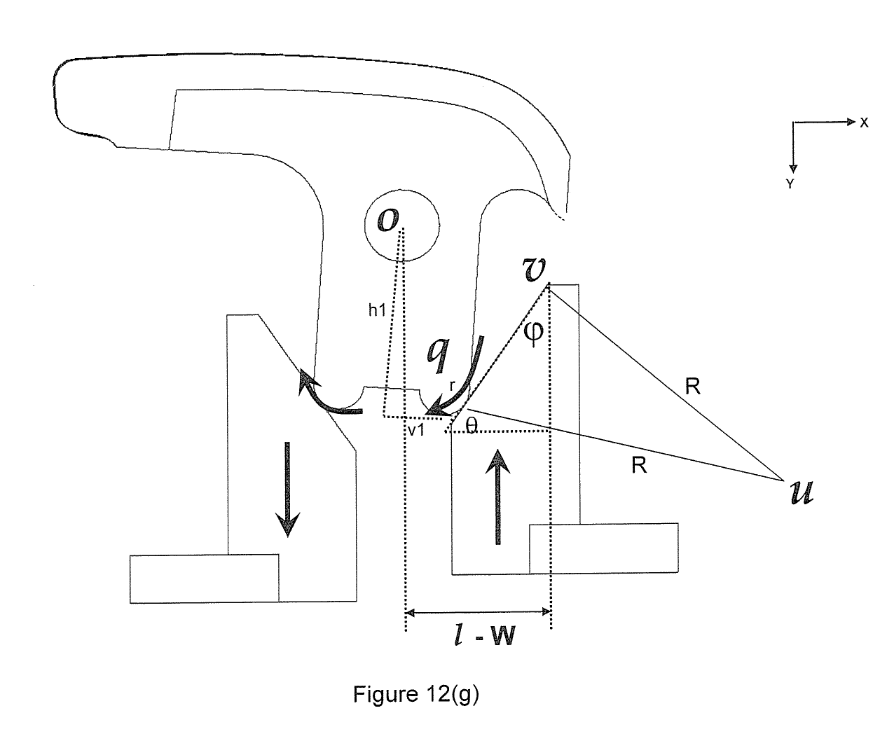

Referring now to FIGS. 12(a) through 12(g) various calculations pertaining to the geometry will now be provided for a plunger element 30 with a curved tip portion 60.

The above variables referenced with respect to FIG. 11 are reused for clarity in FIGS. 12(a) to 12(g) and the following additional variable is used:

ω—Contact angle between plunger element 30 and actuator extension 22.

Similar to the above, FIGS. 12(a) and 12(b) illustrate the variables in relation to the switch assembly 10. Turning to FIG. 12(c), sample force calculations are now provided for the curved-tip plunger element 30. As above, ΣFy=0, ff1=μ1.Fpx, and ff2=μ2.Fp. Then, for activation:

$$\begin{matrix}Fe + ff 1 + ff 2 \cdot Sin ω = Fpy ⇒ Fe + μ 1 \cdot Fpx + μ 2 \cdot {\overbrace{Fp \cdot Sin ω}}^{Fpx} \\ Fpy\end{matrix} \qquad ( {1}^{′} )$$

and for deactivation:

$$\begin{matrix}Fe - ff 1 - ff 2 \cdot Sin ω = Fpy ⇒ Fe - μ 1 \cdot Fpx - μ 2 \cdot {\underbrace{Fp \cdot Sin ω}}_{Fpx} \\ = Fpy .\end{matrix} \qquad ( {2}^{′} )$$

### Also,

$$\begin{matrix}tan ω = \frac{Fpx}{Fpy} ⇒ Fpx = Fpy tan ω and & ( {3}^{′} ) \\ Cos ω = \frac{Fpy}{Fp} ⇒ Fpy = FpCos ω , & ( {4}^{′} )\end{matrix}$$

therefore, for activation:

Fe+μ1.Fpy.tan ω+μ2.Fpy tan ω=Fpy [symbol] Fe=Fpy(1−μ1.tan ω−μ2.tan ω) (5′)

and for deactivation:

Fe−μ1.Fpy.tan ω−μ2.Fpy.tan ω=Fpy [symbol] Fe=Fpy(1+μ1.tan ω+μ2.tan ω) (6′).

According to equation (4′), Fpy=Fp Cos ω and thus for activation:

Fe=Fp.Cos ω(1−μ1.tan ω−μ2.tan ω) (7′)

and for deactivation:

Fe=Fp.Cos ω(1+μ1.tan ω+μ2.tan ω) (8′).

Turning now to FIG. 12(d), KO=h1, XO=h2, KX=h3, and

h1=h2+h3 (9′).

It can also be seen that ΔXQK:

$$\begin{matrix}tan ( ω - \vert {α}^{->} \vert ) = \frac{v 1}{h 3} ⇒ h 3 \\ = \frac{v 1}{tan ( ω - \vert {α}^{->} \vert )} and Δ XJO \text{:} sin ( ω - \vert {α}^{->} \vert ) \\ = \frac{d}{h 2} ⇒ h 2 \\ = \frac{d}{sin ( ω - \vert {α}^{->} \vert )} .\end{matrix}$$

Then,

$$\begin{matrix}h 2 + h 3 = \frac{v 1}{tan ( ω - \vert \vec{α} \vert )} + \frac{d}{sin ( ω - \vert \vec{α} \vert )} \\ = \frac{v 1 Cos ( ω - \vert \vec{α} \vert ) + d}{sin ( ω - \vert \vec{α} \vert )} ,\end{matrix} \\ and \text{:} h 1 = \frac{v 1 Cos ( ω - \vert \vec{α} \vert ) + d}{sin ( ω - \vert \vec{α} \vert )} . \qquad ( {10}^{′} )$$

It can also be seen that

$$d = h 1 Sin ( ω - \vert \vec{α} \vert ) - \frac{v 1 Sin ( ω - \vert \vec{α} \vert )}{tan ( ω - \vert \vec{α} \vert )}$$

and thus

d=h1 Sin(ω−|\vec{α}|)−v1 Cos(ω−|\vec{α}|) (11′).

If the moment arm is

m=QJ (12′)

and

$$\begin{matrix}QJ = QX + XJ & ( {13}^{′} ) \\ for Δ XQK \text{:} Sin ( ω - \vert \vec{α} \vert ) = \frac{v 1}{QX} ⇒ QX = \frac{v 1}{Sin ( ω - \vert \vec{α} \vert )} \\ and & ( 14 {a}^{′} ) \\ Δ XJO \text{:} tan ( ω - \vert \vec{α} \vert ) = \frac{d}{XJ} ⇒ XJ = \frac{d}{tan ( ω - \vert \vec{α} \vert )} . & ( 14 {b}^{′} )\end{matrix}$$

### Then,

$$QX + XJ = \frac{v 1}{Sin ( ω - \vert \vec{α} \vert )} + \frac{d}{tan ( ω - \vert \vec{α} \vert )} = \frac{v 1 + d Cos ( ω - \vert \vec{α} \vert )}{sin ( ω - \vert \vec{α} \vert )}$$

and the moment arm can be defined as:

$$m = \frac{v 1 + d Cos ( ω - \vert \vec{α} \vert )}{sin ( ω - \vert \vec{α} \vert )} . \qquad ( {15}^{′} )$$

Referring now to FIG. 12(e), ΣMo=0 and f2=μ2.Fp as above, and for activation: −b.Fc+d.Fp+ff2(m+r)=0 [symbol] b.Fc=Fp[d+μ2(m+r)] and thus

$$Fc = Fp ( \frac{d + μ 2 ( m + r )}{b} ) . \qquad ( {16}^{′} )$$

Also, for deactivation:

$$- b \cdot Fc + d \cdot Fp - ff 2 ( m + r ) = 0 ⇒ b \cdot Fc = Fp [ d - μ 2 ( m + r ) ] \\ and thus Fc = Fp ( \frac{d - μ 2 ( m + r )}{b} ) . \qquad ( {17}^{′} )$$

Using equations (7′) and (16′), for activation:

$$\frac{Fc}{Fe} = \frac{Fp ( \frac{d + μ 2 ( m + r )}{b} )}{Fp \cdot Cos θ ( 1 - μ 1 \cdot tan θ - μ 2 \cdot tan θ )}$$

and thus

$$Fc = Fe ( \frac{d + μ 2 ( m + r )}{b \cdot Cos θ ( 1 - μ 1 \cdot tan θ - μ 2 \cdot tan θ )} ) . \qquad ( {18}^{′} )$$

Then, using equations (8′) and (17′), for deactivation:

$$\frac{Fc}{Fe} = \frac{Fp ( \frac{d - μ 2 ( m + r )}{b} )}{Fp \cdot Cos θ ( 1 + μ 1 \cdot tan θ + μ 2 \cdot tan θ )}$$

and thus

$$Fc = Fe ( \frac{d - μ 2 ( m + r )}{b \cdot Cos θ ( 1 + μ 1 \cdot tan θ + μ 2 \cdot tan θ )} ) . \qquad ( {19}^{′} )$$

In these equations, m is calculated from equation (15′) and d is calculated from equation (11′).

Turning now to FIG. 12(f), sample kinematic equations are provided below for the curved plunger element 30. It can be seen in this figure that |\vec{OS′ₓ}|=|h1.Sin \vec{α}|+|v1.Cos \vec{α}|+|r.Sin ω| and |\vec{S′Uₓ}|=|R.Sin ω|. As such,

uₓ=|\vec{OS′ₓ}|+|\vec{S′Uₓ}| [symbol] uₓ=|=h1.Sin \vec{α}|+|v1.Cos \vec{α}|+|r.Sin ω|+|R.Sin ω| (20′).

When the angle of rotation of the actuator 18 is

α=0→ω=θ,uₓis const. [symbol] uₓ₀uₓ=|v1|+|r.Sin θ|+|R.Sin θ| (21′).

### Also,

qₓ=|h1.Sin \vec{α}|+|v1.Cos \vec{α}| (22′)

and

q_{y}=|h1.Cos \vec{α}|−|v1.Sin \vec{α}| (23′).

Now,

$$\{ \begin{matrix}{\vert \vec{qu} \vert}^{2} = {( R + r )}^{2} \\ {\vert \vec{qu} \vert}^{2} = Δ {x}^{2} + Δ {y}^{2}\end{matrix} \} ⇒ {( R + r )}^{2} = Δ {x}^{2} + Δ {y}^{2} ,$$

where (R+r)²=(uₓ−qₓ)²+(u_{y}−q_{y})², (u_{y}−q_{y})²=(R+r)²−(uₓ−qₓ)², and thus:

u_{y}=q_{y}±\sqrt{(R+r)²−(uₓ−qₓ)²} (24′).

Next, using equations (21′), (22′) and (23′) and inserting the values into equation (24′), when the angle of rotation of the actuator 18 is α=0→u_{y}=u_{y0},H=H0, ΔH=Δu_{y}, H=H0+ΔH [symbol] H=H0+Δu_{y}, and thus:

H=H0+u_{y}−u_{y0} (25′).

To determine the contact angle ω between the plunger element 30 and the actuator extension 22,

$$Sin ω = \frac{Δ x}{R + r} ⇒ ω = {Sin}^{- 1} ( \frac{Δ x}{R + r} ) , \\ and thus ω = {Sin}^{- 1} ( \frac{{u}_{x} - {q}_{x}}{R + r} ) . \qquad ( {26}^{′} )$$

Consequently,

$$\begin{matrix}L = \vec{\vert {OS}_{xMax +}^{′} \vert} + W , & ( {27}^{′} ) \\ \begin{matrix}\vec{\vert {OS}_{x 0}^{′} \vert} = \vert h 1 \cdot Sin 0 \vert + \vert v 1 \cdot Cos 0 \vert + \vert r \cdot Sin θ \vert ⇒ \vec{\vert {OS}_{x 0}^{′} \vert} \\ = \vert v 1 \vert + \vert r \cdot Sin θ \vert ,\end{matrix} \\ \vec{\vert {S}^{′} {T}_{x} \vert} = L - \vec{\vert {OS}_{x 0}^{′} \vert} ⇒ \vert \vec{{S}^{′} T} \vert = \frac{L - \vec{\vert {OS}_{x 0}^{′} \vert}}{Cos θ} , and & ( {28}^{′} ) \\ \begin{matrix}\vec{\vert {OS}_{y 0}^{′} \vert} = \vert h 1 \cdot Cos 0 \vert - \vert v 1 \cdot Sin 0 \vert + \vert r \cdot Cos θ \vert ⇒ \vec{\vert {OS}_{y 0}^{′} \vert} \\ = \vert h 1 \vert + \vert r \cdot Cos θ \vert .\end{matrix} & ( {29}^{′} )\end{matrix}$$

Turning to FIG. 12(g), sample calculations related to this figure apply only to the first few degrees of rotation while preload is in effect, as above. Forces derived from the opposing plunger element 30 are deducted from the main plunger element 30.

It can be seen in FIG. 12(g) that |\vec{OS′_{xUP}}|=−|h1.Sin \vec{α}|+|v1.Cos \vec{+}|+|r.Sin ω|, |\vec{S′U_{xUP}}|=|R.Sin ω|, and thus:

u_{xUP}=|\vec{OS′_{xUP}}|+|\vec{S′U_{xUP}}| [symbol] u_{xUP}=−|h1.Sin \vec{α}|+|v1.Cos \vec{α}|+|r.Sin ω|+|R.Sin ω| (30′).

Consequently, when the angle of rotation of the actuator 18 is α=0→ω=θ,

u_{xUP} is const. [symbol] u_{x0UP}=u_{xUP}=|v1|+|r.Sin θ|+|R.Sin θ| (31′).

Next,

q_{xUP}=−|h1.Sin \vec{α}|+|v1.Cos \vec{α}| (32′)

and

q_{yUP}=|h1.Cos \vec{α}|+|v1.Sin \vec{α}| (33′).

From this,

$$\{ \begin{matrix}{\vert \vec{qu} \vert}^{2} = {( R + r )}^{2} \\ {\vert \vec{qu} \vert}^{2} = Δ {x}^{2} + Δ {y}^{2}\end{matrix} \} ⇒ {( R + r )}^{2} = Δ {x}^{2} + Δ {y}^{2} ,$$

which gives (R+r)²=(uₓ−qₓ)²+(u_{y}−q_{y})², (u_{y}−q_{y})²=(R+r)²−(uₓ−qₓ)², and thus

u_{yUP}=q_{yUP}±\sqrt{(R+r)²−(u_{xUP}−q_{xUP})²} (34′).

Then, by inserting equations (31′), (32′), and (33′) in equation (34′), when the angle of rotation of the actuator 18 is α=0→u_{y}=u_{yUP0}, Hup=H0up, ΔHup=Δu_{yUP}, Hup=H0up+ΔHup [symbol] Hup=H0up+Δu_{yUP}, and

Hup=H0up+u_{yUP}−u_{y0UP} (35′).

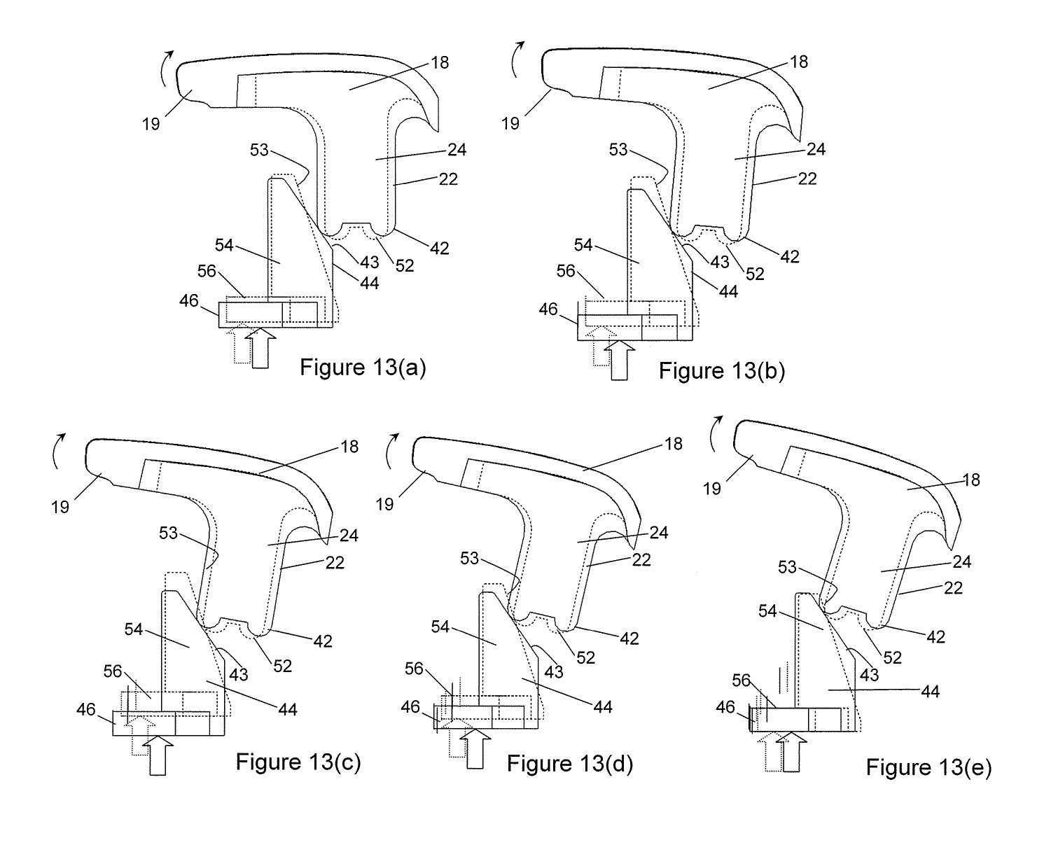

Various stages of activation for the switch assembly 10 are shown in FIGS. 13(a) through 13(e) for a dual-stage activation in one direction, wherein a pair of electrical contacts are made sequentially. In these figures, the primary plunger element 30 and primary extension 22 are shown in solid lines and the secondary plunger element 32 and secondary extension 24 are shown in dotted lines to illustrate the sequential operation. For clarity, the domes 36 are omitted from the diagrams in FIGS. 13(a)-13(e) with respective solid and dotted arrows provided instead to illustrate the forces that the domes 36 impart on the plunger elements 30, 32. FIG. 13(a) illustrates the rest or neutral position wherein both primary plungers 30 are in contact with their corresponding tips 42 and wherein slight engagement is provided to minimize rattling of the plunger elements 30 (only one plunger element 30 is shown for ease of explanation). The slight engagement at rest is often referred to as “preload”. As discussed earlier and also shown in FIG. 13(a), the secondary tips 52 are not in contact with the secondary plunger elements 32 in the rest position in order to provide sequential engagement and activation.

FIGS. 13(b) and 13(c) illustrate activation of the first electrical contact, namely the collapsing of a first dome 36 to make contact with the underlying PCB 38. In this first stage of the dual-stage activation, the primary plunger element 30 has been forced in a downward direction by the arc made by the primary tip 42 which in turn forces the underlying dome 36 to collapse and make the first electrical contact and the first detent is simultaneously felt by the user. At the completion of the first stage, the secondary tip 52 has made contact with the sloped surface 53 of the secondary plunger 32 as best seen in FIG. 13(c).

FIGS. 13(d) and 13(e) illustrate activation of the second electrical contact in the second stage of the dual-stage activation. In the second stage, the secondary plunger element 32 has been forced in a downward direction by the arc made by the secondary tip 52 which in turn forces the underlying dome 36 (which would be laterally spaced in this example from the first dome 36 which has been collapsed) to collapse and make the second electrical contact while the first electrical connection is held. At this stage, a second detent should be provided to the user. It can be appreciated from FIG. 13(e) that at the end of travel, the geometry of the plunger elements 30, 32 and the radii of the extension tips 42, 52 impart an optimal travel distance to make a reliable electrical contact without adversely affecting the durability of the domes 36. It may be noted that each dome 36 is typically designed by an e-pad designer having a specification that specifies maximum travel of the dome 36. For example, a suitable dome 36 used for evaluating the above principles was designed to travel 1.4 mm to electrical contact and another 0.5 mm for a total of 1.9 mm to its limit. Therefore, the travel for this range would be more than 1.4 and less than 1.9 mm and these ranges would be incorporated into the calculations. In the example shown herein, because the travel for the primary and secondary domes 36 are identical, the full travel for primary and secondary contacts would be equal.

It may be noted that the dome travel is important to the operability of the overall switch assembly 10 since less than a minimum amount of travel reduces the likelihood of a reliable electrical contact being made whereas greater than a maximum amount of travel can adversely affect the durability of the dome 36 whereby the dome 36 fails prematurely.

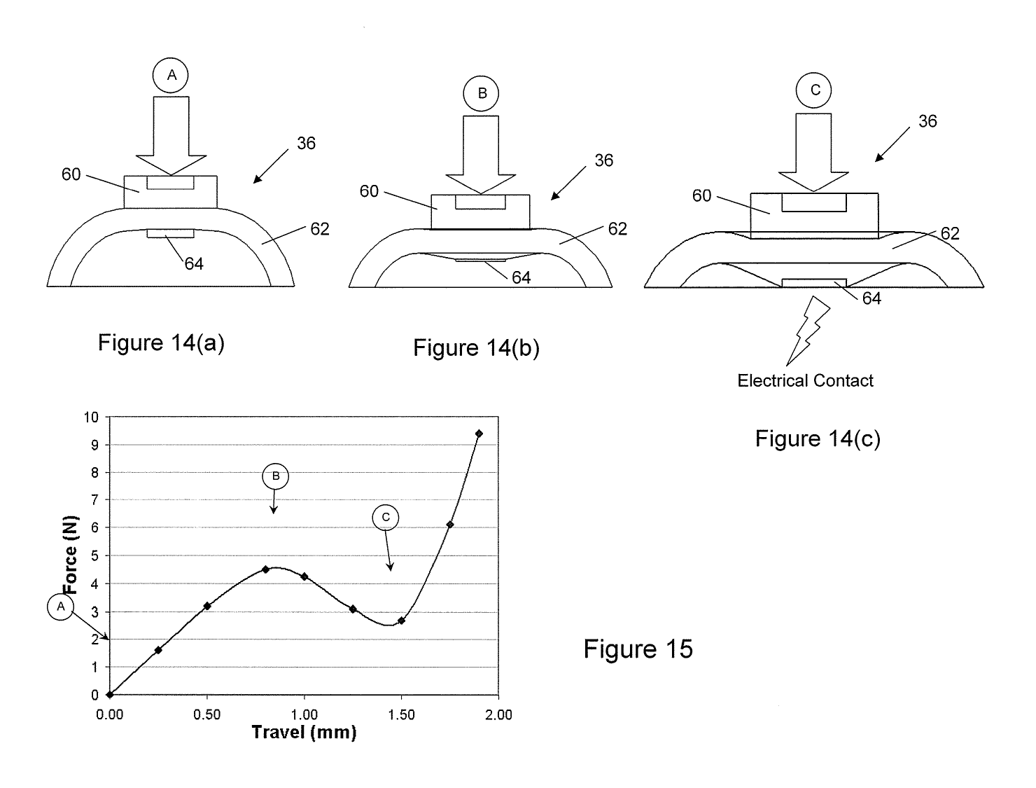

FIGS. 14(a) through 14(c) show further detail of and the corresponding stages for activation of the domes 36. Each dome 36 comprises actuation surface 60 supported atop an annular collapsible member 62. The underside of the actuation surface 60 where it attaches to the collapsible member 62 is an upper electrical contact 64 that when engaging an underlying lower electrical contact or trace on the PCB 38 (not shown) closes a circuit on the PCB 38. In stage A, as the force imparted on the actuation surface 60 increases, the mechanical resistance of the dome 36 increases. In stage B, at this point in travel, the dome 36 moves past the “snap-over point” wherein the mechanical resistance begins to decrease and the travel speed increases. Then, at stage C, the electrical contact is established by the upper contact 64 engaging the PCB 38. It may be noted that if the dome 36 is forced to further collapse beyond this point, the mechanical resistance increases once again, due to the compressibility of the e-pad material. FIG. 15 illustrates a force-travel curve for the dome 36 shown in FIGS. 14(a) to 14(c).

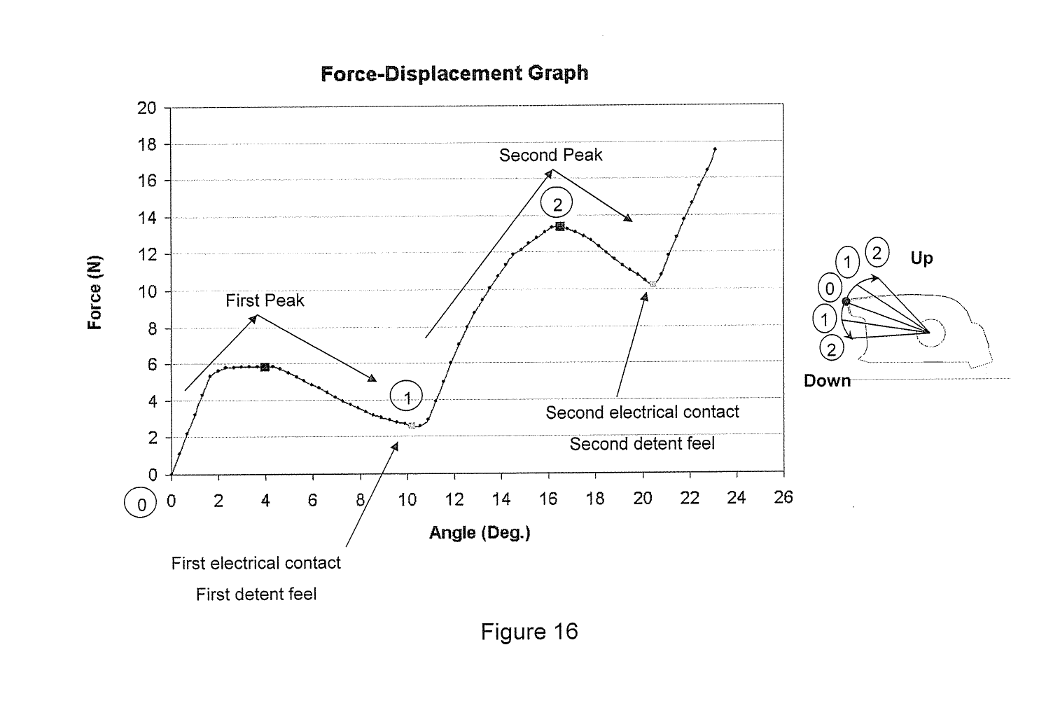

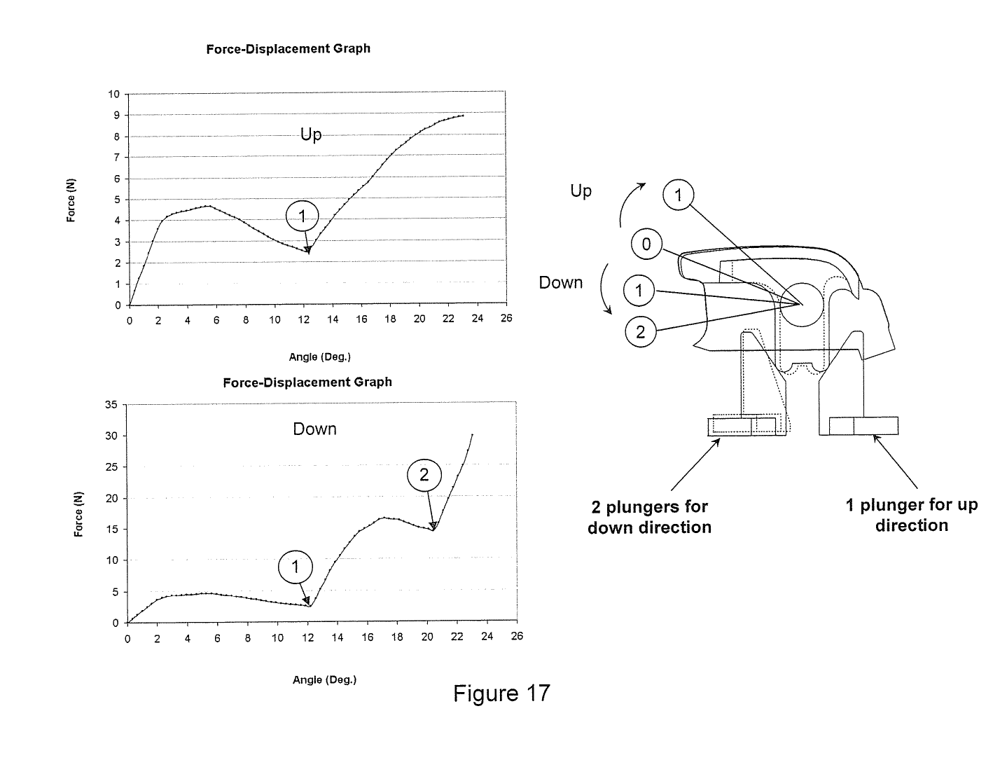

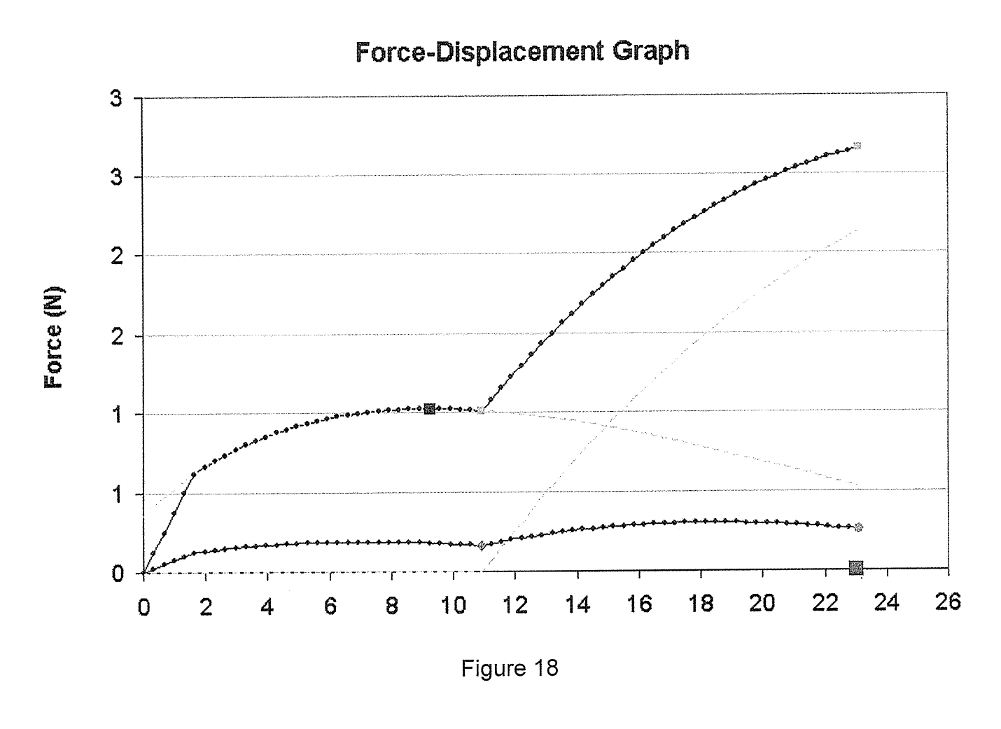

E-pad domes 36 are commonly used in automotive, communication, computer, and other applications. As such, it can be appreciated that the principles of the plunger elements 30, 32 and the sequential operation can be applied beyond automotive applications. It may be noted that in some applications, various versions of the same switch assembly 10 are needed. For example, the same switch assembly 10 may be desired for applications wherein the secondary function is desired and others wherein the secondary function is not desired. Using the configuration herein described, all that is needed to add or remove secondary functions in either direction of actuation, is the addition or removal of either or both of the secondary plunger elements 32. This provides various combinations of single or dual detent operations in the respective directions. For example, FIG. 16 illustrates a force-angle graph for a two-stage actuation which is applicable to both directions if both secondary plunger elements 32 are used. FIG. 17 illustrates an example wherein both the primary and secondary plunger elements 30, 32 are provided for the “down” direction and only the primary plunger element 30 is provided for the “up” direction. The force-angle graphs in FIG. 17 illustrate that the down direction in this example has two distinct detents whereas the up direction experiences only one detent. FIG. 18 illustrates a tactile response in an embodiment using springs rather than an e-pad 34 and shows the absence of the peaks that are experienced as seen in FIG. 16.

Therefore, the configuration described herein offers the flexibility to produce a “family” of switch assemblies 10 since it can be easily arranged to provide 1, 2, 3, or 4 electrical functions. The combinations listed in Table 1 below are achieved by adding or removing one or both of the secondary plunger assemblies 32 as noted above (using FIG. 5 as a reference for forward versus rearward). Alternatively, a single, unidirectional combination can be achieved by incorporating a limiter (not shown) to limit actuator movement in one direction or the other.

TABLE 1
Switch Family Combinations

| Combination | Description | Configuration |
|---|---|---|
| 1a | One down function | Front primary plunger for forward |
| | only | movement and limiter for rearward |
| | | movement |
| 1b | One up function only | Rear primary plunger for rearward |
| | | movement and limiter for forward |
| | | movement |
| 2a | One down function | Both primary plungers and one |
| | and two up functions | rearward secondary plunger |
| 2b | One up function and | Both primary plungers and one |
| | two down functions | forward secondary plunger |
| 3 | One up function and | Both primary plungers and no |
| | one down function | secondary plungers |
| 4 | Two up functions and | All four plungers |
| | two down functions | |

Using the above-described electrical switch assembly 10, the overall tactile response of the assembly 10 can be customized independently of the tactile profile of the e-pad 34, therefore eliminating the need to change the e-pad 34 to provide different tactile profiles. By changing the geometry of the plunger elements 30, 32 and extensions 22, 24, the amount of force for each detent can be adjusted to suit a particular application, which enables a wide range of forces to be achieved using variations in such geometry. Moreover, the travel-to-actuation for each switching stage can be adjusted, which corresponds to the number of degrees of rotation required to reach the first and second detents. This flexibility is provided with changes only to the geometry of the plunger elements 30, 32 and the actuator 18, independent of the e-pad 34. This is particularly advantageous since typically the travel and force ranges available for a given dome 36 are quite limited. Also, changing the characteristics of the e-pad 34 such as force and travel can typically only be done by changing the entire geometry, which is time consuming and expensive and the results of which are not fully predictable and thus require verification through testing. The durability of the e-pad 34 may be affected by any such changes and thus a full durability test would also be required after each change to the e-pad 34 which is undesirable. Therefore, providing the ability to change the tactile feel of an electrical switch assembly 10 without these considerations is considerably desirable.

The durability and reliability of the domes 36 is also maintained using the configuration described herein because the constrained linear motion of the plunger elements 30, 32 illustrated in FIGS. 5 and 6 protects the domes 36 from non-axial operation, which can occur with the traditional designs discussed earlier. Furthermore, the travel of the domes 36 can be optimized by changing the geometry of the components (discussed above) to maximize the life of the e-pad 34. The package size for the configurations exemplified herein can be made relatively small. For example, it has been found that the assembly 10 shown in FIG. 2 can be produced with overall dimensions of 26 mm (L)×23 mm (W)×34 mm (H). However, it can be appreciated that even smaller package sizes can be achieved.

The minimal number of components and simple layout of the electrical switch assembly 10 herein described can contribute to a less expensive product that can be manufactured more easily while minimizing resultant manufacturing errors. The configuration and the assembly shown in FIG. 3 can be manufactured using low volume/manual environments or high volume/automated environments.

Unlike other e-pad-based switch assemblies (not shown), the switch assembly 10 shown herein uses the direction and angle of the forces among the components to create mechanical advantage in a small package, increasing the resultant force on the knob that is generated by the e-pad 34 and enabling the actuator 18 to have a larger range of travel as shown in FIGS. 13(a) through 13(e). The direction of the forces contributes to a more accurate function because the plunger elements 30, 32 are side loaded using the outer guide members 48. Therefore, only the outer surface of the plungers 30, 32 and the corresponding surfaces of the housing 20 need to be controlled to get better performance uniformity across a large number of manufactured parts. In total, fewer dimensions need to be controlled to reduce variance between different produced parts (i.e. manufacturing tolerances).

Although the above principles have been described with reference to certain specific embodiments, various modifications thereof will be apparent to those skilled in the art without departing from the scope of the claims appended hereto.

1. An electrical switch assembly comprising:
a housing;
an actuator supported by said housing, said actuator having one or more downward extensions each having at least one arcuate tip;
an electrical circuit contained in said housing;
an elastomeric pad comprising one or more collapsible domes overlying said electrical circuit; and
one or more plunger elements supported in said housing between said actuator and respective ones of said domes, each plunger element comprising a sloped surface to engage said arcuate tip during movement of said actuator to cause said plunger element to collapse an underlying dome.

2. The assembly according to claim 1, wherein said housing is configured to constrain each plunger element to substantially upward and downward movements.

3. The assembly according to claim 1, wherein said arcuate tip is rounded.

4. The assembly according to claim 1, wherein said sloped surface further comprises a curvature.

5. The assembly according to claim 1 comprising a primary plunger element, a secondary plunger element, a primary extension, and a secondary extension, wherein said primary extension is configured to be closer in distance to said primary plunger element than the distance between said secondary extension and said secondary plunger in a rest position such that movement of said actuator causes said primary plunger element to move prior to said secondary plunger element.

6. The assembly according to claim 5 comprising a pair of oppositely spaced primary plunger elements and a pair of oppositely spaced secondary plunger elements, wherein movement of said actuator in one direction causes one of said pair of primary plunger elements to actuate prior to one of said secondary plunger elements and movement of said actuator in another direction causes the other of said pair of primary plunger elements to actuate prior to the other of said secondary plunger elements.

7. A plunger element for actuating an underlying collapsible dome in an electrical switch assembly, said plunger element comprising:
a base portion for engaging said collapsible dome; and
a body extending from said base portion, said body comprising an upwardly facing sloped surface to interact with an actuator having a portion moving in an arc towards said sloped surface and thereby effect downward movement of said plunger towards said dome.

8. The plunger element according to claim 7, wherein said body is sized to enable a housing to constrain said plunger element to substantially upward and downward movements.

9. The plunger element according to claim 7, wherein said sloped surface further comprises a curvature.

10. An electrical switch assembly comprising an actuator operating on a plunger element moveable within the assembly to actuate an electrical circuit, said plunger element comprising a sloped surface for interacting with an member configured to move in an arc under control of the actuator to actuate the electrical circuit.

11. The assembly according to claim 10, further comprising a housing configured to constrain said plunger element to substantially upward and downward movements.

12. The assembly according to claim 10, wherein said member comprises an arcuate tip.

13. The assembly according to claim 12, wherein said arcuate tip is rounded.

14. The assembly according to claim 10, wherein said sloped surface further comprises a curvature.

15. The assembly according to claim 10 comprising a primary plunger element and a secondary plunger element, wherein said member comprises a primary extension and a secondary extension, and wherein said primary extension is configured to be closer in distance to said primary plunger element than the distance between said secondary extension and said secondary plunger in a rest position such that movement of said actuator causes said primary plunger element to move prior to said secondary plunger element.

16. The assembly according to claim 15 comprising a pair of oppositely spaced primary plunger elements and a pair of oppositely spaced secondary plunger elements, wherein movement of said actuator in one direction causes one of said pair of primary plunger elements to actuate prior to one of said secondary plunger elements and movement of said actuator in another direction causes the other of said pair of primary plunger elements to actuate prior to the other of said secondary plunger elements.
